(19) United States
(12) Patent Application Publication
(10) Pub. No.: US 2016/0277506 A1
(43) Pub. Date: Sep. 22, 2016

(54) METHOD AND SYSTEM FOR ONE-TIME CONNECTION

(71) Applicant: National Tsing Hua University, Hsinchu City (TW)

(72) Inventors: Shan-Hung Wu, Hsinchu (TW); Shao-Kan Pi, Taichung City (TW); Ting-Yu Cheng, Taichung City (TW)

(21) Appl. No.: 14/710,599

(22) Filed: May 13, 2015

(30) Foreign Application Priority Data
Mar. 20, 2015 (TW) 104108979

(51) Int. Cl. H04L 29/08; G06Q 30/06; G06Q 30/08

(52) U.S. Cl. CPC H04L 67/141; G06Q 30/08; G06Q 30/0613

(57) ABSTRACT

A method and an apparatus for one-time connection are provided. In the method, a first apparatus generates a connection item according to first connection information, in which the first connection information is previously registered in a server. Next, a second apparatus obtains the connection item and accordingly generates a virtual card. The second apparatus further uploads the virtual card and second connection information to the server to register the virtual card in the server. Then, the second apparatus receives a selecting operation for the virtual card and accordingly uploads a connection request of using the virtual card to the server. The server establishes a one-time connection between the second apparatus and the first apparatus according to the virtual card, the first connection information and the second connection information.

### CROSS-REFERENCE TO RELATED APPLICATION

This application claims the priority benefit of Taiwan application serial no. 104108979, filed on Mar. 20, 2015. The entirety of the above-mentioned patent application is hereby incorporated by reference herein and made a part of this specification.

### BACKGROUND

1. Field of the Invention

The invention is directed to a method and a system for communication and more particularly, to a method and a system for one-time connection.

2. Description of Related Art

In occasions, such as visiting clients, attending seminars and attending speeches, people usually meet strangers and sometimes need to chat with or get acquainted with these strangers to establish social relationships. Due to limited time, people can chat with one another shortly and provide personal contact information to other parties by, in most cases, exchanging business cards or presenting telephone numbers, email addresses or social network accounts if desiring to keep in touch subsequently.

However, the contact information is private, and thus, in case such information is provided to a stranger, he/she may use the information to not only get in touch, but also reveal the information to others, which may cause harassment from the other party or other strangers to the user, or put the user is a risk of being unfavorably harmed by people having intentions to abuse the information. Therefore, a safe channel for preventing other parties from abusing the contact information during the presence of the contact information is needed.

### SUMMARY

The invention provides a method and a system for one-time connection, through which a virtual card associated with contact information of one party is provided to the other party allowing the other party to contact the party by using the virtual card, but the virtual card is restricted to being deleted after being used and thereby, the contact information can be prevented from being abused.

According to an embodiment of the invention, a method for one-time connection adapted for a second apparatus to establish a one-time connection to a first apparatus is provided. In the method, a connection item is generated by the first apparatus according to first connection information, wherein the first connection information is previously registered in a server. Then, the connection item is obtained to accordingly generate a virtual card by the second apparatus, and the virtual card and second connection information are uploaded to the server to register the virtual card in the server. Afterwards, a selecting operation for the virtual card is received by the second apparatus to accordingly upload a connection request of using the virtual card to the server. A one-time connection is established between the second apparatus and the first apparatus by the server according to the virtual card, the first connection information and the second connection information.

In an embodiment of the invention, the step of obtaining the connection item by the second apparatus includes photographing the connection item, or receiving the connection item through a wireless connection technique, wherein the connection item includes a two-dimensional (2-D) barcode (e.g., a QR code), and the wireless connection technique includes a Bluetooth, an infrared (IR) or a near field communication (NFC) technique.

In an embodiment of the invention, after the step of uploading the virtual card and the second connection information to the server to register the virtual card in the server by the second apparatus, the method further includes updating a first card list on the first apparatus; and updating a second card list on the second apparatus by the server, wherein the first card list includes virtual cards associated with the first connection information among all virtual cards that are registered in the server, and the second card list includes all virtual cards of the second apparatus that are registered in the server.

In an embodiment of the invention, before the step of establishing the one-time connection between the second apparatus and the first apparatus according to the virtual card, the first connection information and the second connection information by the server, the method further includes pushing a notification to the first apparatus according to the first connection information to query the first apparatus whether to accept the connection request by the server; and determining by the server whether to establish the one-time connection according to a confirmation message returned by the first apparatus.

In an embodiment of the invention, after the step of establishing the one-time connection between the second apparatus and the first apparatus according to the virtual card by the server, the method further includes deleting the virtual card by the server when the one-time connection is terminated.

In an embodiment of the invention, after the step of uploading the virtual card and the second connection information to the server to register the virtual card in the server by the second apparatus, the method further includes registering a selling price of the virtual card to the server and transmitting a selling link of the virtual card to a third apparatus by the second apparatus; connecting to the server to bid for the virtual card and paying the selling price according to the selling link by the third apparatus; and registering the virtual card as belonging to the third apparatus winning the bid according to third connection information of the third apparatus by the server.

According to an embodiment of the invention, a system for one-time connection including a server, a first apparatus and a second apparatus is provided. The first apparatus first registers connection information in the server and generates a connection item according to the first connection information. The second apparatus obtains the connection item, accordingly generates a virtual card, and uploads the virtual card and second connection information to the server to register the virtual card in the server. When receiving a selecting operation for the virtual card, the second apparatus uploads a connection request of using the virtual card to the server, and the server establishes a one-time connection between the second apparatus and the first apparatus according to the virtual card, the first connection information and the second connection information.

In an embodiment of the invention, the server pushes a notification to the first apparatus according to the first connection information to query the first apparatus whether to accept the connection request and determines whether to establish the one-time connection according to a confirmation message returned by the first apparatus.

In an embodiment of the invention, the server further deletes the virtual card when the one-time connection is terminated.

In an embodiment of the invention, the system for one-time connection further includes a third apparatus. The second apparatus registers a selling price of the virtual card to the server and transmits a selling link of the virtual card to a third apparatus. The third apparatus connects to the server according to the selling link and pays the selling price. The server registers the virtual card as belonging to the third apparatus according to third connection information of the third apparatus.

To sum up, in the method and the system for one-time connection of the invention, the contact information of the first apparatus is registered in the server, and the connection item is generated according to the contact information and provided to the second apparatus. The second apparatus can generate the virtual card according to the connection item and contact with the first apparatus by using the virtual card. The virtual card is automatically deleted after being used, and thereby, the contact information can be prevented from being abused.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a one-time connection system according to an embodiment of the invention.

FIG. 2 is a flowchart illustrating a method for one-time connection according to an embodiment of the invention.

FIG. 3 is a flowchart of an example of the method for one-time connection according to an embodiment of the invention.

FIG. 4 is a flowchart illustrating a method of trading the virtual card according to an embodiment of the invention.

### DESCRIPTION OF EMBODIMENTS

The invention provides a method and a system capable of packaging user's contact information as a virtual E-card and restricting the number of times and conditions for using virtual card by means of the management of a server. Thereby, the user can safely share the contact information with others, without worrying about her/his contact information being abused. In addition, the invention further provides a virtual card trading platform for the user who obtains a virtual card to transfer or sell the virtual card to another person, and in this way, the application range of the virtual card of the invention can be extended.

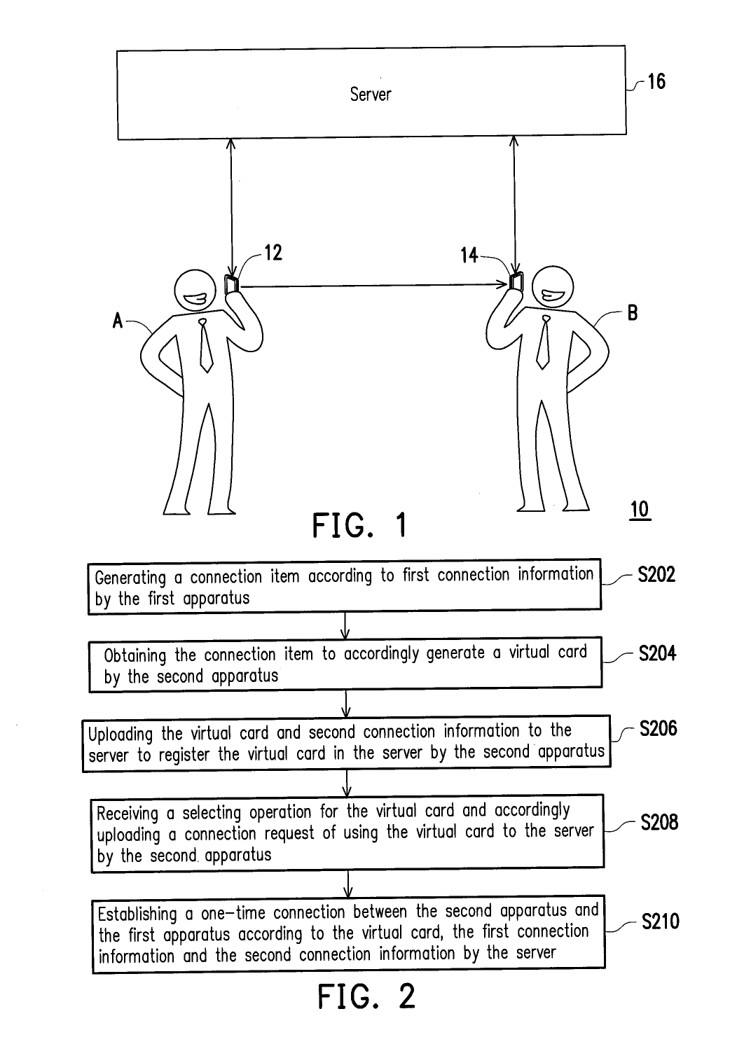

FIG. 1 is a schematic diagram illustrating a one-time connection system according to an embodiment of the invention. With reference to FIG. 1, a one-time connection system 10 of the present embodiment includes a first apparatus 12, a second apparatus 14 and a server 16. The first apparatus 12 and the second apparatus 14 are electronic apparatuses, such as smart phones, personal digital assistants (PDAs), tablet PCs, notebook computers or multi-media players and are respectively owned by users A and B, for example, such that the user A may share contact information thereof with the user B. The server 16 is a calculating equipment configured at a service end and having a computing capability, such as a file server, a database server, an application server, a work station or a personal computer. Types of the first apparatus 12, the second apparatus 14 and the server 16 are illustrated merely as examples and should construe no limitations to the invention.

FIG. 2 is a flowchart illustrating a method for one-time connection according to an embodiment of the invention. With reference to both FIG. 1 and FIG. 2, the method of the present embodiment is adapted for the one-time connection system 10. Hereinafter, the detailed process of the method of the present embodiment will be described with reference to each element of the one-time connection system 10 illustrated in FIG. 1.

First, the first apparatus 12 generates a connection item according to first connection information (step S202). The connection item may be, for example, a one-dimensional (1-D) barcode or a two-dimensional (2-D) barcode (e.g., a quick response code (QR code)) containing information related to the first apparatus 12, and the electronic apparatus obtaining the connection item may generate a virtual card associated with the first apparatus 12.

It should be noted that before the first apparatus 12 generates the connection item, the user A may previously register the first connection information in the server 16, and accordingly, the first apparatus 12 may generate the exclusive connection item thereof, such that another apparatus may generate a virtual card by using the connection item to establish a connection to the first apparatus 12 through the server 16. The first connection information may be, for example, an apparatus identification (ID), an internet protocol address (IP address), a media access control address (MAC address), a telephone number, an email address, an instant messaging (IM) software account, a social network account or similar information or a combination thereof of the first apparatus 12, which is not limited in the invention.

Then, the second apparatus 14 obtains the connection item and accordingly, generates a virtual card (step S204). Herein, in an embodiment, the connection item generated by the first apparatus 12 may be, for example, a QR code, and the second apparatus 14 may photograph QR code using a camera and interpret information stored in the QR code, so as to generate a virtual card. In another embodiment, the connection item generated by the first apparatus 12 may be, for example, a 1-D barcode, 2-D barcode or any other object containing information related to the first apparatus 12, and the second apparatus 14 may receive the connection item from the first apparatus 12 by using a wireless connection technique, such as a Bluetooth, an infrared (IR) or a near field communication (NFC) technique, so as to generate the virtual card.

It should be noted that the user A of the first apparatus 12 may select a contact manner (e.g., voice dialogue, video dialogue or instant messaging (IM)) for sharing based on his/her demand, such that the first apparatus 12 may generate connection items with different properties. After obtaining the connection items, the second apparatus 14 may generate different types of virtual cards, such as a voice dialogue card, a video dialogue card and an IM card to allow the user B to contact with the user A of the first apparatus 12 in a corresponding contact manner. Additionally, the first apparatus 12 may also set a valid duration (e.g., ½ hour) for the connection item generated thereby to restrict an apparatus obtaining the connection item to generating a valid virtual card only within the valid duration, so as to ensure that the connection item may be prevented from being abused.

After generating the virtual card, the second apparatus 14 may upload the virtual card together with second connection information thereof to the server 16 to register the virtual card in the server 16 (step S206). Similarly, the second connection information may be, for example, an ID, an IP address, an MAC address, a telephone number, an email address, an IM software account, a social network account or similar information or a combination thereof of the second apparatus 14 for the server 16 to accordingly establish the connection between the second apparatus 14 and the first apparatus 12 according to the second connection information, which is not limited in the invention.

It should be noted that the first apparatus 12 stores a first card list, and the second apparatus 14 stores a second card list. Therein, the first card list may record, for example, virtual cards associated with the first connection information among all virtual cards that are registered in the server 16, and thereby, the user A may realize which users own his/her virtual cards. The second card list records all virtual cards that are registered in the server by the second apparatus 14, and thereby, the user B may realize which users have the virtual cards owned by the second apparatus 14. The server 16 may—confirm that the second apparatus 14 obtains a virtual card of an apparatus (e.g., the first apparatus 12) whenever the second apparatus 14 registers a virtual card in the server 16, and in this circumstance, the server 16 updates the first card list on the first apparatus 12 and the second card list on the second apparatus 14 respectively, so as to add the newly registered virtual card into the first card list and the second card list. Specially, the user A only knows about which users own the virtual card thereof, but is not permitted to contact with these users, while the user B is permitted to use the virtual cards to contact with the corresponding users.

In detail, the second apparatus 14 may receive a selecting operation for the virtual card from the user B and accordingly upload a connection request of using the virtual card to the server 16 (step S208). Therein, the second apparatus 14 may, for example, display the second card list on a screen thereof, such that the user B may select a virtual card of a user that he/she wants to contact with from the second card list.

After receiving the connection request, the server 16, for example, searches for the first connection information and the second connection information associated with the virtual card that are recorded in a database, so as to establish a one-time connection between the second apparatus 14 and the first apparatus 12 according to the virtual card, the first connection information and the second connection information (step S210). In an embodiment, after receiving the connection request, the server 16 may automatically attempt to establish the one-time connection between the second apparatus 14 and the first apparatus 12. Alternatively, in another embodiment, after receiving the connection request, the server 16 may first query the first apparatus 12 and then determine whether to establish the connection. In this case, the server 16 may, for example, transmit a push notification to the first apparatus 12 according to the first connection information associated with the virtual card to query the user A of the first apparatus 12 whether to accept the connection request and determine whether to establish the one-time connection according to a confirmation message returned by the first apparatus 12. If the user A does not accept or respond the connection request, the connection request is automatically terminated after a period of time. Otherwise, if the user A accepts the connection request, the server 16 establishes the one-time connection between the second apparatus 14 and the first apparatus 12 by means of, for example, establishing a dialogue using an extensible messaging and presence protocol (XMPP) for the users A and B to communicate with each other through the dialogue.

It should be noted that the one-time connection refers to the connection between the second apparatus 14 and the first apparatus 12 is established only once, without permission for repeated establishment and with a limited connection duration. In detail, if one party terminates the connection, or the connection duration is over a predetermined time (e.g., ½ hour), the server 16 deletes the registered but used virtual card, and thereafter, the second apparatus 14 is no longer allowed to connect to the first apparatus 12 by using the virtual card.

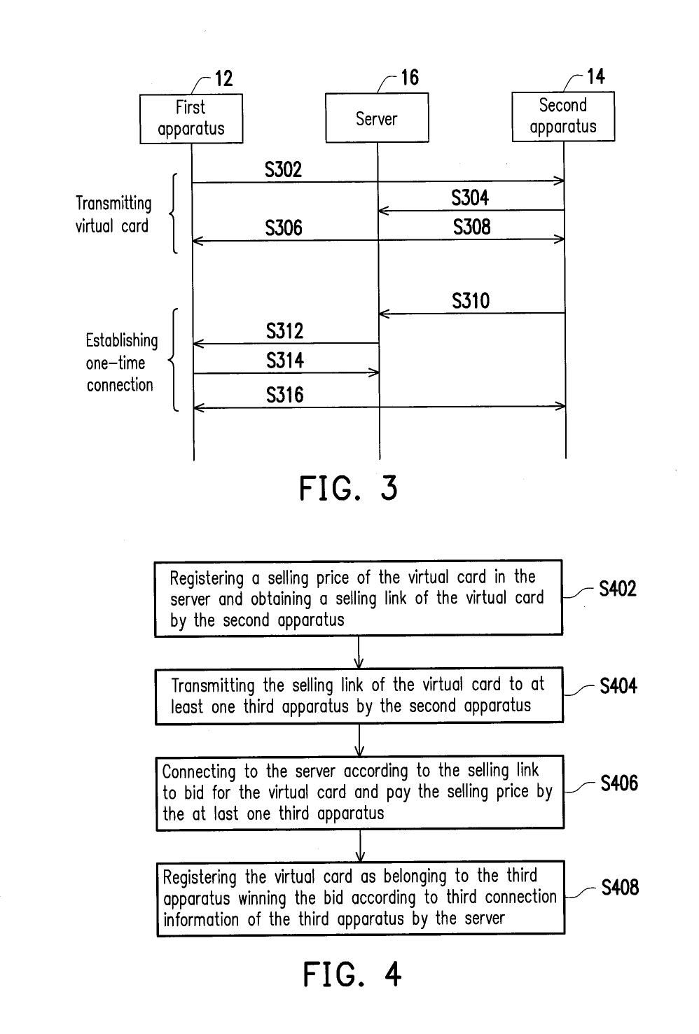

For instance, FIG. 3 is a flowchart of an example of the method for one-time connection according to an embodiment of the invention. With reference to both FIG. 1 and FIG. 3, the method of the present embodiment is adapted for the one-time connection system 10. Hereinafter, the detailed process of the method of the present embodiment will be described with reference to each element of the one-time connection system 10 illustrated in FIG. 1.

First, during the stage of transmitting a virtual card, the first apparatus 12, for example, generates a QR code according to the first connection information thereof and displays it on the screen, such that the second apparatus 14 photographs the QR code to generate the virtual card (step S302).

Then, the second apparatus 14 uploads the virtual card to the server 16, so as to register the virtual card in the server 16 (step S304). Therein, the server 16 may, for example, store the virtual card and the second connection information of the second apparatus 14 owning the virtual card in a database.

Thereafter, the server 16 simultaneously updates the first card list on the first apparatus 12 and the second card list on the second apparatus 14 (step S306), so that the user of the first apparatus 12 may realize which users own the virtual card of the first apparatus 12, and the user of the second apparatus 14 may realize which users' virtual cards are owned by the second apparatus 14.

During the stage of establishing a one-time connection, when the user B of the second apparatus 14 wants to contact with the user A, the user B selects the virtual card of the first apparatus 12 from the second card list displayed on the second apparatus 14, and thereby, the second apparatus 14 generates and uploads a connection request of using the virtual card to the server 16 (step S310). After receiving the connection request searches in the database to verify data of the virtual card and then the server 16 transmits a push-notification to the first apparatus 12 according to the first connection information associated with the virtual card to query the user A of the first apparatus 12 whether to accept the connection request (step S312).

The user A of the first apparatus 12 determines whether to accept the connection request and accordingly returns a confirmation message to the server 16 (step S314), and the server 16 determines whether to establish the one-time connection according to the confirmation message. If the user A does not accept the connection request or does not respond after a period of time, the server 16 cancels the dialogue and notifies both parties (step S316). On the other hand, if the user A accepts the connection request, the server 16 establishes the one-time connection between the second apparatus 14 and the first apparatus 12 and deletes the virtual card when the one-time connection is terminated (step S316).

By means of the method for one-time connection of the preceding embodiment, the user can safely provide contact information thereof to the other party, and then, the other party can contact with the user afterwards, without misusing the contact information, such that the contact information may be prevented from being abused.

It should be noted that in addition to the mechanism for providing the one-time connection between the electronic apparatuses by using the virtual card, the invention further provides a trading mechanism for the virtual card, such that the user obtaining the virtual card may transfer or sell the virtual card to another party. In this way, the application rang of the virtual card can be extended.

For instance, FIG. 4 is a flowchart illustrating a method of trading the virtual card according to an embodiment of the invention. With reference to both FIG. 1 and FIG. 4 the method of the present embodiment is adapted for the one-time connection system 10. Hereinafter, the detailed process of the method of the present embodiment will be described with reference to each element of the one-time connection system 10 illustrated in FIG. 1.

First, the user B of the second apparatus 14 determines a selling price of the virtual card, and the second apparatus 14 registers the selling price of the virtual card in the server 16 and obtains a selling link of the virtual card (step S402). The selling link may be, for example, a link of a bid web page of the virtual card or any other link for other people to connect to the server 16 and browse sale information of the virtual card, which is not limited in the invention.

Then, the user B of the second apparatus 14 may determine parties that the virtual card is to be sold to, such that the second apparatus 14 transmits the selling link to third apparatuses (not shown) owned by the objects (step S404). Therein, the objects to whom the user B may sell the virtual card to are not limited to one, and many people may simultaneously bid for obtaining the virtual card.

Then, the third apparatuses connect to the server 16 according to the selling link provided by the second apparatus 14 to bid for the virtual card and pay the selling price (step S406). Therein, the user B of the second apparatus 14 may sell the virtual card to a single user, register a selling manner in the server 16, transmit the selling link to a third apparatus owned by the user and obtain the ownership of the virtual card when the user connects to the server 16 according to the selling link and pays the selling price. Alternatively, the user B of the second apparatus 14 may also provide the virtual card to a plurality of users for bidding, and in the same way, register the selling manner in the server 16 and transmit the selling link to the third apparatuses owned by the users, such that the user may connect to the server 16 according to the selling link to bid for the virtual card on the server 16, and the user who finally wins the bid may obtain the ownership of the virtual card after paying the selling price of the virtual card.

In detail, when receiving the payment paid to the second apparatus 14 by the third apparatus winning the bid, the server 16 registers the virtual card as belonging to the third apparatus winning the bid according to third connection information of the third apparatus (step S406), so as to complete the transaction of the virtual card. In this way, the user of the third apparatus obtaining the virtual card may contact with the user A of the first apparatus 12 by using the virtual card through one of the mechanisms for one-time connection introduced in the embodiments above, where the detailed contact manners have been described in the embodiments above and thus, will not be repeated.

To summarize, in the method and the system for one-time connection of the invention, the contact information is shared by means of providing the virtual card, and the virtual card is restricted to being used only once, such that the contact information can be prevented from being abused while being provided. Moreover, the invention further provides the trading platform for the virtual card for the user who obtains the virtual card to transfer or sell the virtual card to another person, and in this way, the application range of the virtual card of the invention can be extended.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for one-time connection, adapted for a second apparatus to establish a one-time connection with a first apparatus, the method comprising:
generating a connection item according to first connection information by the first apparatus, wherein the first connection information is previously registered in a server;
obtaining the connection item to accordingly generate a virtual card by the second apparatus;
uploading the virtual card and second connection information to the server to register the virtual card in the server by the second apparatus;
receiving a selecting operation for the virtual card and accordingly uploading a connection request of using the virtual card to the server by the second apparatus; and
establishing a one-time connection between the second apparatus and the first apparatus according to the virtual card, the first connection information and the second connection information by the server.

2. The method according to claim 1, wherein the step of obtaining the connection item by the second apparatus comprises:
photographing the connection item, or receiving the connection item through a wireless connection technique, wherein the connection item comprises a one-dimensional (1-D) barcode or a two-dimensional (2-D) barcode, and the wireless connection technique comprises a Bluetooth, an infrared (IR) or a near field communication (NFC) technique.

3. The method according to claim 1, wherein after the step of uploading the virtual card and the second connection information to the server to register the virtual card in the server by the second apparatus, the method further comprises:
updating a first card list on the first apparatus by the server, wherein the first card list comprises virtual cards associated with the first connection information among all virtual cards that are registered in the server; and
updating a second card list on the second apparatus by the server, wherein the second card list comprises all virtual cards of the second apparatus that are registered in the server.

4. The method according to claim 1, wherein before the step of establishing the one-time connection between the second apparatus and the first apparatus according to the virtual card, the first connection information and the second connection information by the server, the method further comprises:
pushing a notification to the first apparatus according to the first connection information to query the first apparatus whether to accept the connection request by the server; and
determining by the server whether to establish the one-time connection according to a confirmation message returned by the first apparatus.

5. The method according to claim 1, wherein after the step of establishing the one-time connection between the second apparatus and the first apparatus according to the virtual card by the server, the first connection information and the second connection information by the server, the method further comprises:
deleting the virtual card by the server when the one-time connection is terminated.

6. The method according to claim 1, wherein after the step of uploading the virtual card and the second connection information to the server to register the virtual card in the server by the second apparatus, the method further comprises:
registering a selling price of the virtual card in the server and obtaining a selling link of the virtual card by the second apparatus;
transmitting the selling link of the virtual card to at least one third apparatus by the second apparatus;
connecting to the server according to the selling link to bid for the virtual card and pay the selling price by the at last one third apparatus; and
registering the virtual card as belonging to the third apparatus winning the bid according to third connection information of the third apparatus by the server.

7. A system for one-time connection, comprising:
a server;
a first apparatus, configured to register first connection information in the server and accordingly generate a connection item according to the first connection information; and
a second apparatus, configured to obtain the connection item, accordingly generate a virtual card, and upload the virtual card and second connection information to the server to register the virtual card in the server, wherein
when receiving a selecting operation for the virtual card, the second apparatus uploads a connection request of using the virtual card to the server, and the server establishes a one-time connection between the second apparatus and the first apparatus according to the virtual card, the first connection information and the second connection information.

8. The system according to claim 7, wherein the server pushes a notification to the first apparatus according to the first connection information to query the first apparatus whether to accept the connection request and determines whether to establish the one-time connection according to a confirmation message returned by the first apparatus.

9. The system according to claim 7, wherein the server further deletes the virtual card when the one-time connection is terminated.

10. The system according to claim 7, further comprising:
a third apparatus, wherein
the second apparatus uploads a selling price of the virtual card to the server and transmits a selling link of the virtual card to the third apparatus;
the apparatus connects to the server according to the selling link and pays the selling price; and
the server registers the virtual card as belonging to the third apparatus according to third connection information of the third apparatus.
